(19) United States
(12) Patent Application Publication
(10) Pub. No.: US 2025/0018987 A1
(43) Pub. Date: Jan. 16, 2025

(54) UTILITY HANDCART

(71) Applicant: Polymule, Inc., Lehi, UT (US)

(72) Inventors: Dennis Charles Draleau, II, Lehi, UT (US); Robert Byron Male, Bountiful, UT (US)

(21) Appl. No.: 18/743,304

(22) Filed: Jun. 14, 2024

Related U.S. Application Data
(60) Provisional application No. 63/508,825, filed on Jun. 16, 2023.

(51) Int. Cl. B62B 1/10; B62B 1/00; B62B 5/06

(52) U.S. Cl. CPC B62B 1/10; B62B 1/008; B62B 5/067; B62B 2207/02

(57) ABSTRACT

A utility handcart can include a container secured to a lower frame. An adjustable, dual-purpose handle and/or kickstand assembly can be adjusted by a user to act as a kickstand when the handcart is stationary and act as a handle for pushing or pulling the handcart. The handle/kickstand assembly can include arms pivotally secured to arm mounts, which extend forward from the lower frame and upward in front of the container. The handcart can be selectively secured to a hitch mounting attachment with a tapered platform for easy mounting and dismounting from a vehicle hitch receiver. The handcart can include struts rotatably securing wheels to define a large, rectangular ground clearance volume beneath the lower frame and between the wheels.

### CROSS-REFERENCE TO RELATED APPLICATION

This application claims priority to U.S. Provisional Patent Application No. 63/508,825, filed 16 Jun. 2023, entitled “Utility Handcart”, the disclosure of which is incorporated herein by reference in its entirety.

### FIELD

The present disclosure relates generally to carts. More particularly, the present disclosure relates to utility handcarts.

### BACKGROUND

Utility carts can be used for a wide variety of work and recreational activities, including outdoor activities on rough terrain and trails. Typical utility carts, including wagons, wheelbarrows, and handcarts, are hard to navigate over rough terrain and lack the broad functionalities needed by users, from outdoor recreation, camping, and everyday hauling to heavier duty activities including hauling wood, traversing mountain trails, search and rescue activities, and humanitarian aid operations in remote areas.

### BRIEF DESCRIPTION OF THE DRAWINGS

The disclosure will be understood by the following description in conjunction with the accompanying drawings, wherein like reference numerals designate like structural elements, and in which:

FIG. 1 illustrates a front, top, perspective view of an example of a handcart according to the present disclosure;

FIG. 2 illustrates a rear, top, perspective view thereof;

FIG. 3 illustrates a rear, bottom, perspective view thereof;

FIG. 4 illustrates a front, bottom, perspective view thereof;

FIG. 5 illustrates a side view thereof;

FIG. 6 illustrates another side view thereof with the wheels removed;

FIG. 7 illustrates a rear, top, perspective view of an example of a handcart with the handle positioned downward, according to the present disclosure;

FIG. 8 illustrates a rear, top, perspective view of an example of a handcart with the handle in a stowed position, according to the present disclosure;

FIG. 9 illustrates a top view of an example of a handcart according to the present disclosure;

FIG. 10 illustrates a bottom view thereof;

FIG. 11 illustrates a rear view thereof;

FIG. 12 illustrates a front view thereof;

FIG. 13 illustrates a front, top, perspective view of an example of a handcart frame according to the present disclosure;

FIG. 14 illustrates a rear, top, perspective view thereof;

FIG. 15 illustrates a lower perspective view of a wheel strut in a stowed position, according to the present disclosure;

FIG. 16 illustrates an example of a hitch attachment for a handcart, according to the present disclosure;

FIG. 17 illustrates a lower, perspective view of a handcart with a hitch attachment accessory, according to the present disclosure;

FIG. 18 illustrates a lower, perspective view of an example of a handcart with a hitch attachment accessory secured to the hitch attachment, according to the present disclosure;

FIG. 19 illustrates a bottom view thereof; and

FIG. 20 illustrates a perspective view thereof.

### DETAILED DESCRIPTION

Detailed reference is provided below to representative examples illustrated in the associated drawings. The descriptions that follow are not intended to limit the examples to one preferred embodiment. Rather, they are intended to cover alternatives, variations, and equivalents within the spirit and scope of the embodiments described below and defined by the associated claims.

The present disclosure relates generally to carts. More particularly, the present disclosure relates to utility handcarts. The utility handcarts described herein can be used in a variety of settings and for a variety of functions, including everyday recreational hauling and heavy-duty outdoor hauling over rough terrain. The handcarts can include an adjustable handle extending from a lower frame. The handle can be selectively positioned downward to act as a kickstand when the cart is stationary. The handle can also be folded up and back in a stowed position. In at least one example, the handle can be pivotally attached to a forward and upward extending arm mount. The arm mount can be removably secured to a lower frame of the handcart at tubular receivers sized to also accommodate vehicle tow hitch accessories.

In at least one example, the handcart can include removable wheels secured to stowable struts. The stowable struts can be lowered to increase ground clearance between the wheels and below the lower frame of the handcart. The struts can be configured such that the clearance is maximized as a rectangular clearance area with a height equal to the radius of the wheels plus the length of the struts.

In at least one example of the present disclosure, a hitch attachment system, including a hitch attachment and a trailer hitch attachment accessory for a handcart can enable quick, easy, and secure attachment of the handcart to a vehicle. In one example, the trailer hitch attachment includes a tapered surface configured to mate with the attachment accessory of the handcart to provide easy alignment of the handcart with the hitch attachment. Once an initial mating of the attachment and accessory is accomplished, the handcart can be easily slid onto and locked in place with the hitch attachment. This makes attaching the handcart to a vehicle hitch easy to do even when the handcart is full of gear.

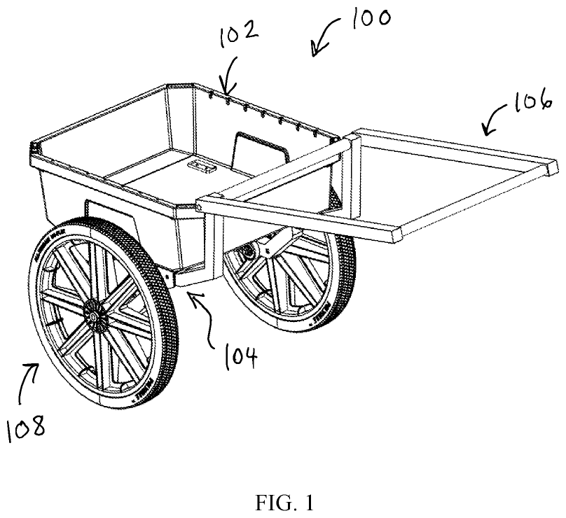

These and other embodiments are discussed below with reference to FIGS. 1-20. However, those skilled in the art will readily appreciate that the detailed description given herein with respect to these figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

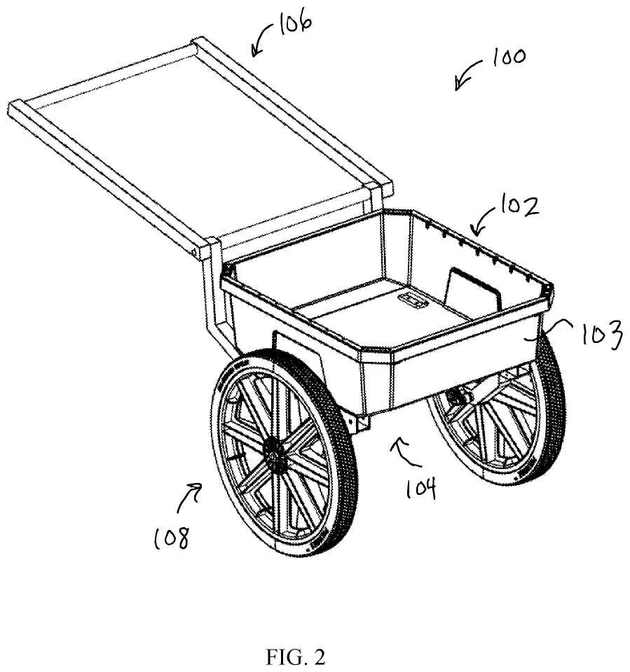

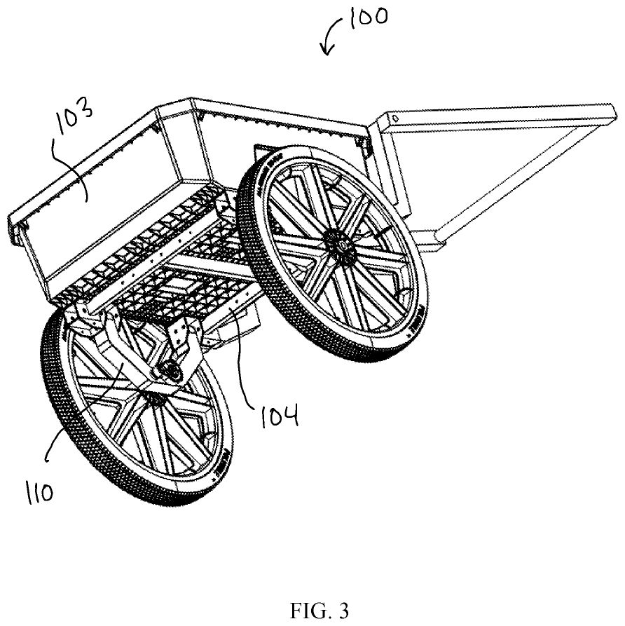

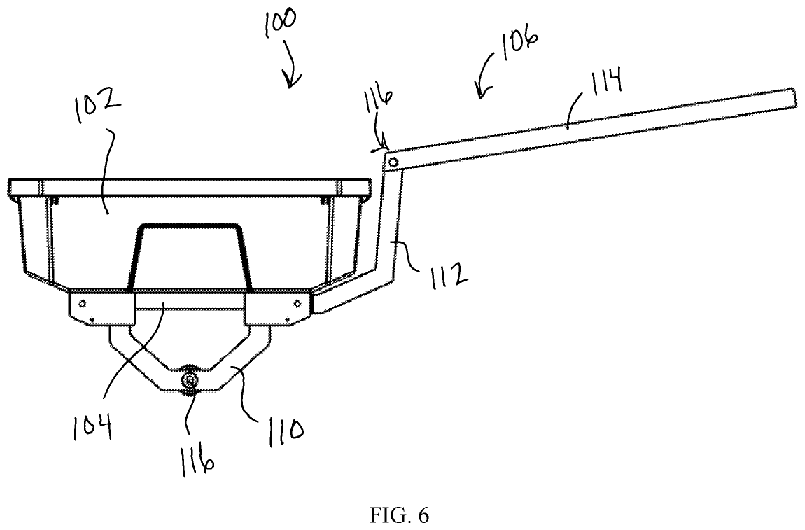

FIG. 1 illustrates a front, top, perspective view of an example of a handcart 100. FIGS. 3-5 illustrate other perspective views thereof and FIG. 6 illustrates a side view of the handcart 100 with the wheels 108 removed. As shown in FIGS. 1-6, the handcart 100 can include a container 102 having a base and sidewalls extending from the base to from a container volume. The container 102 can be molded as a single piece or assembled from multiple pieces. In one example, the sidewalls can be removable such that the container 102 is modular and customizable by the user. In one example, the rear sidewall 103, referenced in FIGS. 2 and 3, is movable or removable. In one example, the rear sidewall is pivotable about a lower axis with the base such that the rear sidewall 103 is operable in a dump configuration. In such a configuration, the rear sidewall 103 can be lowered or pivoted downward to open the rear side of the container 102 and allow the user to dump contents of the container out the back by tipping the handcart 100. Any of the other sidewalls of the container 102 can also be pivotable, removable, or otherwise reconfigurable.

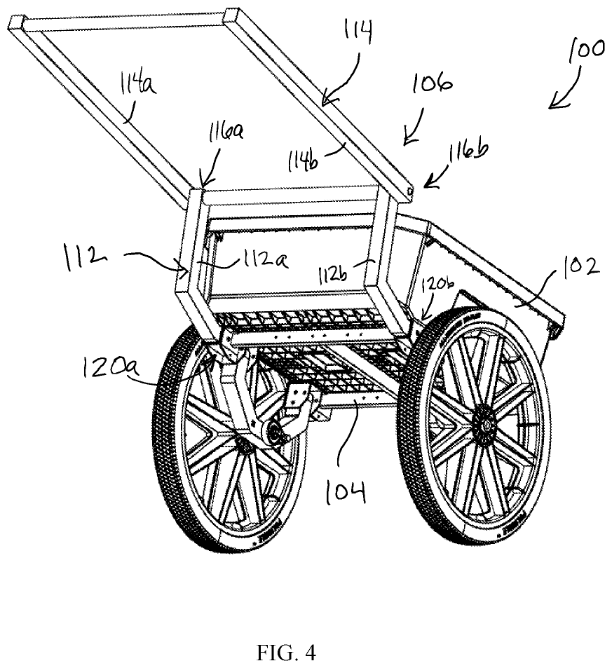

In at least one example, the handcart 100 can include a lower frame 104 onto which the container 102 is secured. The lower frame 104, as shown at least in FIGS. 3 and 4, can include one or more elongate members forming a platform, frame, or chassis onto which the container 102 and other handcart components, including the wheels 108, struts 110, and handle assembly 106 can be mounted. In at least one example, the lower frame 104 can include an H-frame with three elongate members forming an H-shaped frame as shown. In at least one example, the lower frame 104 can be formed of multiple elongate tubes or tubular members formed of durable materials such as metal or plastic. In at least one example, the lower frame 104 can be formed or molded as a single piece. In at least one example, the container 102 can be secured to the lower frame 104 and fixed in position relative thereto.

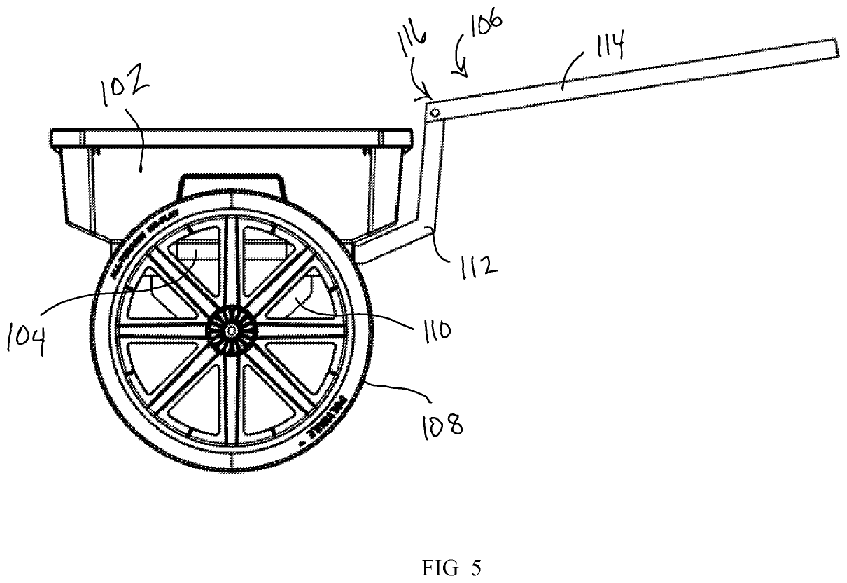

In at least one example, as shown in the side views of FIGS. 5 and 6, with the wheels removed in FIG. 6, the handcart 100 can include a handle assembly 106 extending forward relative to the handcart 100. In at least one example, the handle assembly 106 includes a set of arms 114 pivotally secured to arm mounts 112. The arms 114 can pivotally secure to the arm mounts 112 at a pivot point or joint 116. The arm mounts 112 can extend forward from the lower frame 104 and upward in front of the container 102. The first end of the arm mounts 112 can be secured to the lower frame 104 as shown in FIG. 6 and the pivot joint 116 can be disposed at a second end of the arm mount 112 opposite the first end.

In at least one example, the pivot joint 116 can include a selectively rotatable mechanism for fixing the arms 114 of the handle assembly 106 at various angles relative to the arm mounts 112. In the illustrated example of FIGS. 5 and 6, the arms 114 are positioned and fixed at an angle configured for a user to pull or push the handcart 100. Depending on the height, size, and preference of the user, the arms 114 can be rotated to angles relative to the arm mounts 112 other than that shown in FIGS. 5 and 6. In at least one example, the multi-position pivot mechanism enabling the fixed position and selective change in angle of the arms 114 is disposed inside the arms 114 and the distal/second end of the arm mounts 112. The mechanism can include a trigger or button engageable by the user to instigate a change in position of the arms 114 during adjustments. When the trigger or button is released, the arms 114 can lock in place and be fixed relative to the arm mounts 112. The trigger can interact with a series of detents formed in the pivot mechanism to selectively lock the position of the arms 114 in place.

Any of the features, components, and/or parts, including the arrangements and configurations thereof shown in FIGS. 1-6 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 1-6.

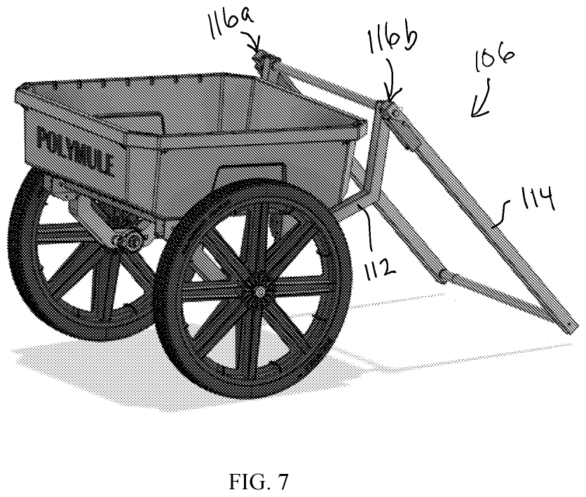

As shown in FIG. 7, in at least one example, the arms 114 of the handle assembly 106 can be positioned downward relative to the arm mounts 112, extending downward from the pivots 116a and 116b. In the illustrated configuration, the handle assembly 106 can be referred to as a kickstand assembly 106 with kickstand arms 114 extending from the kickstand mount 112 secured to the lower frame underneath the container. In at least one example, the pivots 116a-b can include adjustment mechanisms to fix the kickstand arms 114 in place as shown once adjusted by the user. In at least one example, the kickstand arms 114 can be adjusted or pivoted upward to serve as a handle for the user to push or pull the handcart. In the illustrated examples, the arms 114 can act as handle arms and kickstand arms without any other kickstand or handle components. The arms 114 and arm mounts 112 can be dual-purpose and used as a kickstand and/or handles for moving the handcart 100 as needed.

In at least one example, the arms 114 can include length-adjustable telescoping arms. In such an example the user can adjust a length of the arms for comfort or function as needed. For example, in the kickstand configuration shown in FIG. 7, the handle arms 114 can be telescoping handles so the user can adjust a length of the arms 114 if the user needs to park the handcart with the kickstand on uneven terrain where the ground between the wheels 108 and the end of the arms 114 is uneven. The telescoping arms 114 can also be adjusted for accommodating different sizes of users grasping the handle assembly 106 and pushing or pulling the handcart 100.

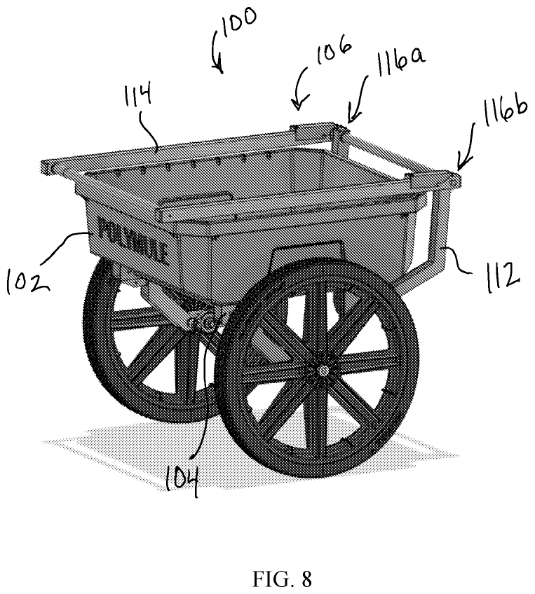

In at least one example, as shown in FIG. 8, the handle arms 114 can be rotated/pivoted at the pivots 116a-b upward and backward as shown such that the container 102 is disposed between the handle arms 114 and the lower frame 103. The arm mounts 112 can remain extending forward from the lower frame 104 and upward in front of the container 102 such that the pivots 116a-b allow the handle arms 114 to be positioned above and generally level with the container 102. This can be a stowed position. The user can configure the handle assembly 106 into this stowed position, with the handle arms 114 fixed in position as shown above the container 102, to minimize an overall footprint of the handcart 100 for efficient and easy storage or transport.

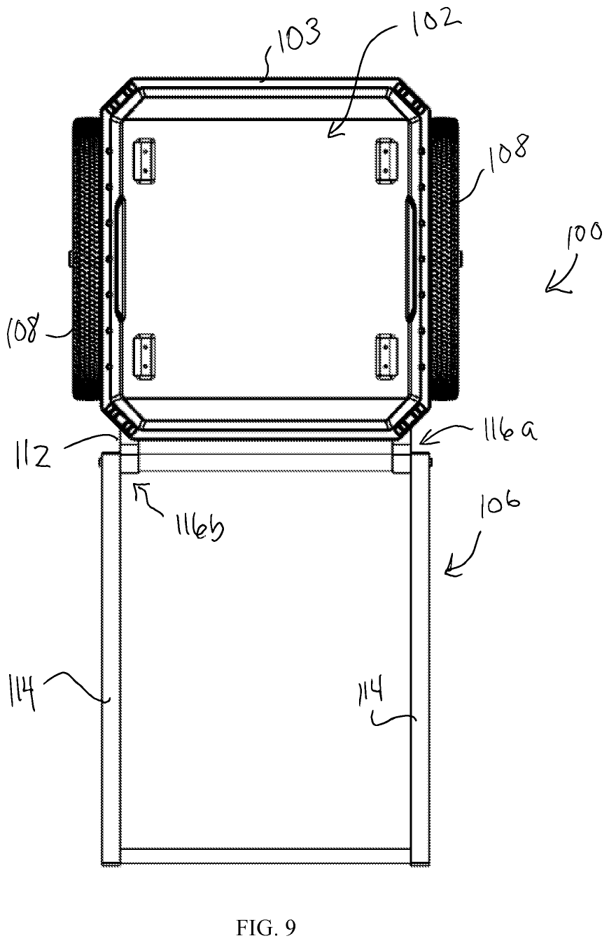

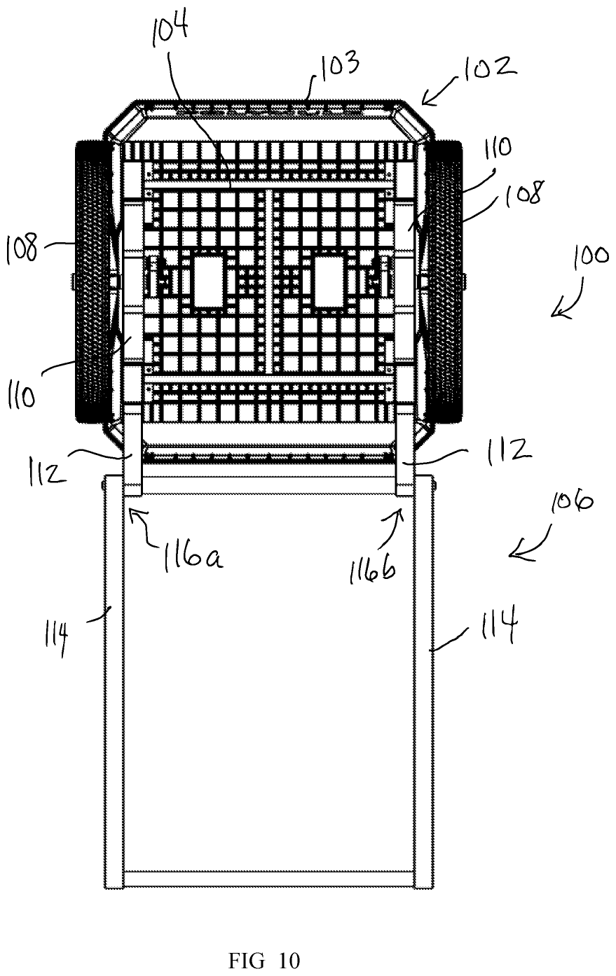

FIGS. 9 and 10 show top and bottom views of the handcart 100, respectively, including the various components thereof described herein.

Any of the features, components, and/or parts, including the arrangements and configurations thereof shown in FIGS. 7-10 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 7-10.

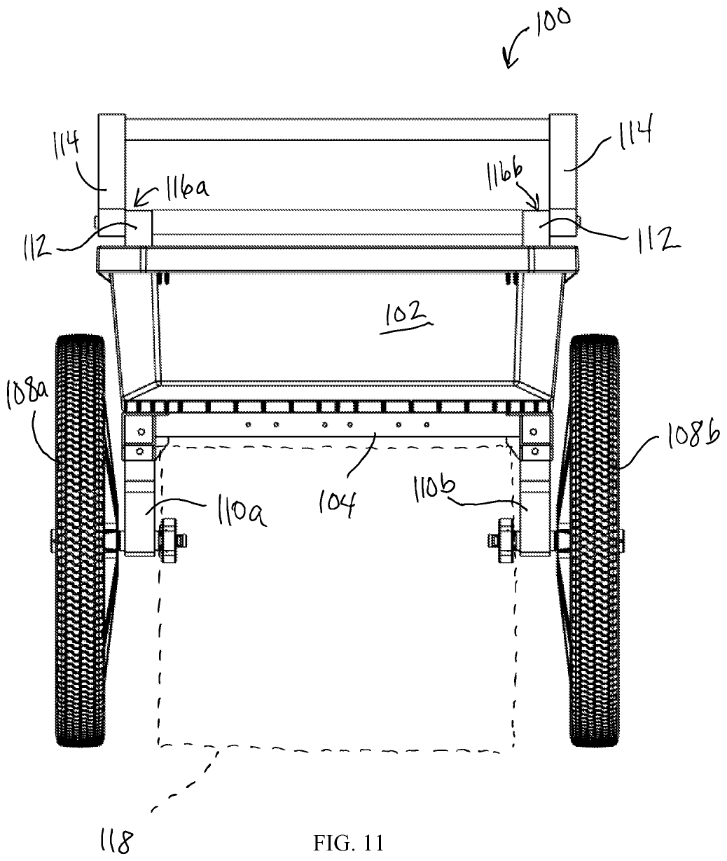

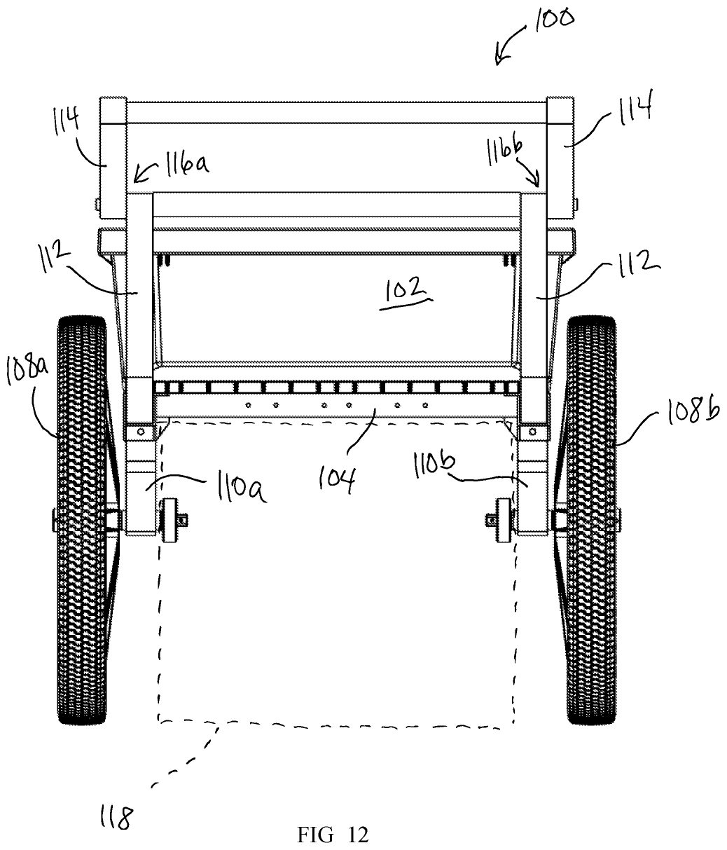

FIGS. 11 and 12 show rear and front views, respectively, of the handcart 100, including first and second wheels 108a, 108b rotatably secured to first and second struts 110a, 110b, respectively. The handcart 100 also includes the container 102 and the handle assembly 106 including the arm mounts 112 and handle arms 114 secured to the arm mounts at pivots 116a-b.

In at least one example, as shown by the rear and front views of FIGS. 11 and 12, respectively, the struts 110a-b, lower frame 104, and wheels 108a-b can define a rectangular cube clearance volume indicated by the rectangular clearance area 118 in dotted lines shown in FIGS. 11 and 12. The clearance area 118 can be rectangular between the wheels 108a-b such that the upper corners of the clearance area 118 are right angles unimpeded by angular supports. The struts 110a-b securing the wheels 108a-b to the lower frame 104 can extend straight down from the lower frame 104 such that the struts 110a-b make right angles with the lower frame 104 to define the rectangular clearance area 118. This configuration maximizes the ground clearance underneath the lower frame 104 and between the wheels 108a-b for clearing obstacles such as rocks and bushes as the user traverses rough terrain with the handcart 100.

The vertical height (vertical as oriented with the rear and front views of FIGS. 11 and 12) can be equal to the radius of the wheels 108a-b plus the length of the struts 110a-b extending downward from the lower frame 104.

Any of the features, components, and/or parts, including the arrangements and configurations thereof shown in FIGS. 11-12 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 11-12.

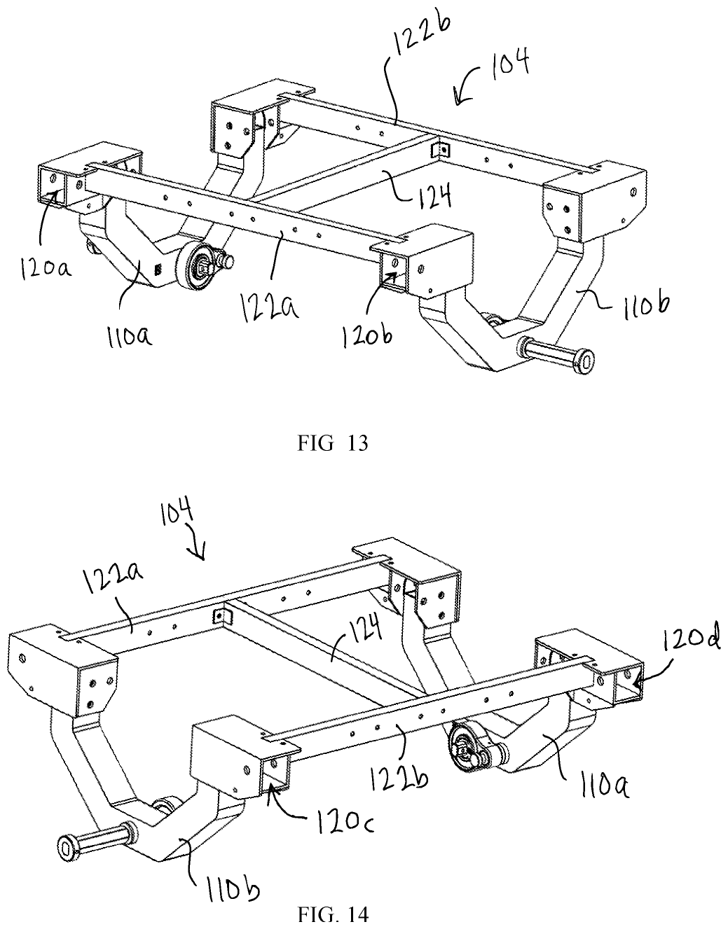

FIG. 13 illustrates a top, front, perspective view of an example of a handcart frame 104 and FIG. 14 shows a rear, top, perspective view thereof. The frame 104 can be configured to fix the handcart container 102 thereto. In at least one example, the frame 104 can define receivers 120a-d configured to receive one or more other components. In at least one example, the first and second receivers 120a-b defined by the frame 104 can be sized, positioned, and shaped to receive the first ends of the arm mounts 112 illustrated in other figures, or the first ends of each extension of the arm mounts 112 illustrated in other figures. For example, FIG. 4 illustrates first and second extensions 112a-b of the arm mount 112 secured to or received in first and second receivers 120a-b, respectively, of the lower frame 104. The handle arms also include first and second arms 114a-b pivotally secured to the first and second extensions 114a-b, respectively, at pivots 116a-b, respectively. The arm mounts 112 can be inserted and fixed within the receivers 120a and 120b to secure the handle assembly 106 to the frame 104. In this example, the handle assembly 106 can be removably secured to the frame 104 and thus to the handcart 100 via the first and second receivers 120a-b.

In at least one example, the third and fourth receivers 120c and 120d, respectively, can be defined rearward and opposite relative to the first and second receivers 120a and 120b. The third and fourth receivers 120c-d can be shaped and sized similar to the first and second receivers 120a-b such that the handle assembly 106 can likewise be removably secured to the frame 104 with the arm mounts 112 of the handle assembly 106 inserted into the third and fourth receivers 120c-d. In one example, the third and fourth receivers 120c-d are shaped and/or sized different than the first and second receivers 120a-b.

In at least one example, one or all of the receivers 120a-d can be shaped, sized, and positioned to receive a hitch attachment or other hitch components to secure the frame 104 and thus the handcart 100 to a vehicle hitch. In at least one example, the receivers 120a-d are shaped and sized such that the handle assembly 106 can be swapped out with other handle assemblies or handcart accessories. In at least one example, the receivers 120a-d are positioned and spaced apart to receive various handcart accessories and components as described herein.

In at least one example, the frame 104 can include an H-frame geometry or configuration including first and second parallel elongate members 122a, 122b and a cross member 124 extending between the first and second elongate members 122a, 122b. In at least one example, the receivers 120a-d can be defined or disposed at either ends of the first and second elongate members 122a, 122b of the frame 104.

Any of the features, components, and/or parts, including the arrangements and configurations thereof shown in FIGS. 13-14 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 13-14.

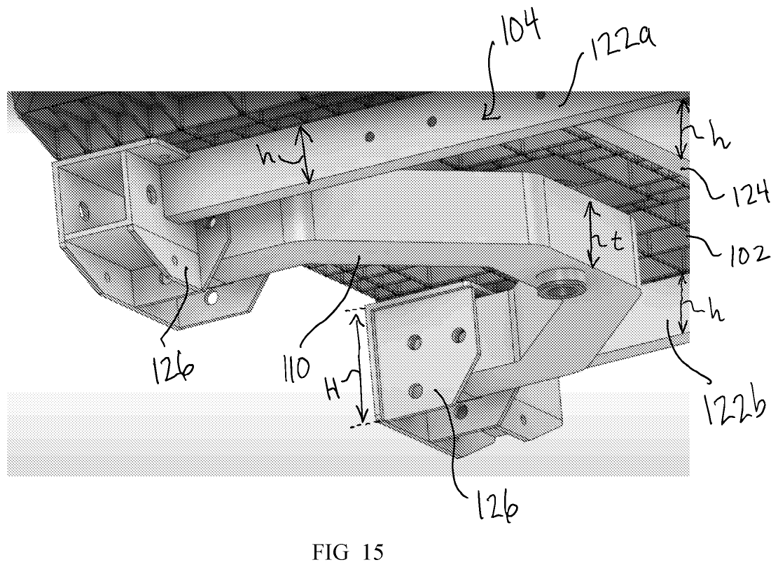

FIG. 15 shows an example of a strut 110 in a stowed position rotated or folded upward against or adjacent a bottom surface of the container 102. The lower frame 104 includes the first and second elongate members 122a-b and the cross member 124, each having a height h extending downward from the container 102. In at least one example, the strut 110 includes or defines a thickness t configured to reside within a space or volume defined by the container 102 and the height h of the frame 104 such that the strut 110 substantially sits within the volume when in the stowed position shown in FIG. 15. In at least one example, joints 126 where the strut 110 is pivotally attached to the frame 104 include a height H extending downward from the container 102. In at least one example, the thickness t of the strut 110 is equal to or less than the height H of the joint 126. In at least one example, the thickness t of the strut 110 is less than or equal to the height h of the frame 104. In any case, the strut 110 can be folded upward to sit against the lower side or surface of the container 102 to minimize a total volumetric footprint of the handcart 100 when in the stowed position shown.

In at least one example, the strut 110 is positioned, configured, and shaped to reside between the first and second elongate members 122a-b and adjacent the cross member 124 as shown. In one example, when both struts 110 are folded upward, the cross member 124 can be disposed between the first and second struts 110 in the stowed position.

Any of the features, components, and/or parts, including the arrangements and configurations thereof shown in FIG. 15 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 15.

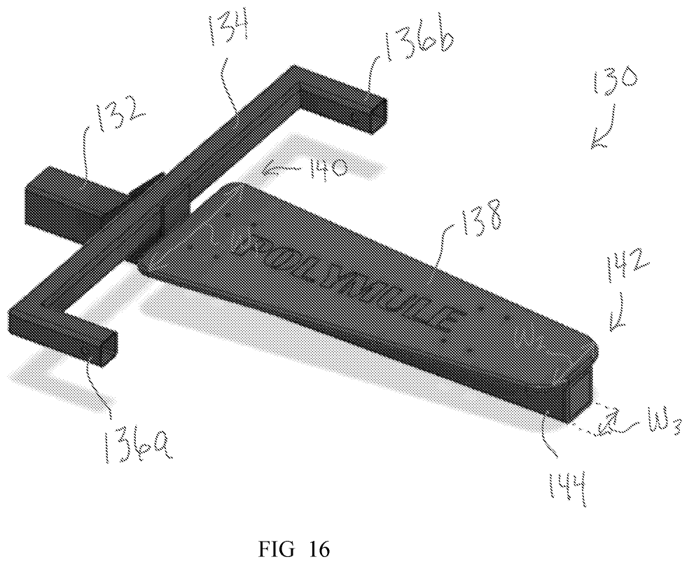

FIG. 16 illustrates an example of a hitch attachment 130 for securing the handcart 100 to a vehicle tow hitch. In the illustrated example, the hitch attachment 130 includes a hitch insert 132 sized and shaped to be received into and secured to a vehicle towing hitch. The hitch attachment 130 can include a tapered platform 138 extending distally from the hitch insert 132. The tapered platform 138 can extend from a first end 140 to a second end 142 distal to the first end 140. The platform 138 can be disposed on top of an elongate member 144 such that the platform 138 overhangs laterally over the elongate member 144.

In at least one example, the platform 138 tapers thinner from the first proximal end 140 to the second distal end 142 such that a lateral width W1 of the first end 140 of the platform 138 is greater than a lateral width W2 of the second end 142 of the platform. As noted above, a width W3 of the elongate member 144 disposed underneath the platform 138 can be less than the first and second widths W1 and W2 of the platform 138 such that the platform 138 laterally overhangs the elongate member 144 on either side thereof and above the elongate member 144.

In at least one example, as shown in FIG. 15, the hitch attachment 130 can include a securement bar 134 extending laterally between the platform 138 and the hitch insert 132 as shown. First and second extensions 136a and 136b, respectively, can extend perpendicular to (e.g., in the same direction as the platform 138 and the elongate member 144) from opposing ends of the securement bar 134 as shown. The first and second extensions 136a and 136b can be positioned, sized, and shaped to be received into the receivers 120a-d of the lower frame 104 of the handcart 100 (e.g., shown in FIGS. 13 and 14. For example, the first extension 136a can be received into the third receiver 120c and the second extension 136b can be received into the fourth receiver 120d. In at least one example, the extensions 136a-b can be received into two corresponding receivers 120a-d and selectively locked in place to selectively secure the frame 104, and thus the handcart 100, to the hitch attachment 130.

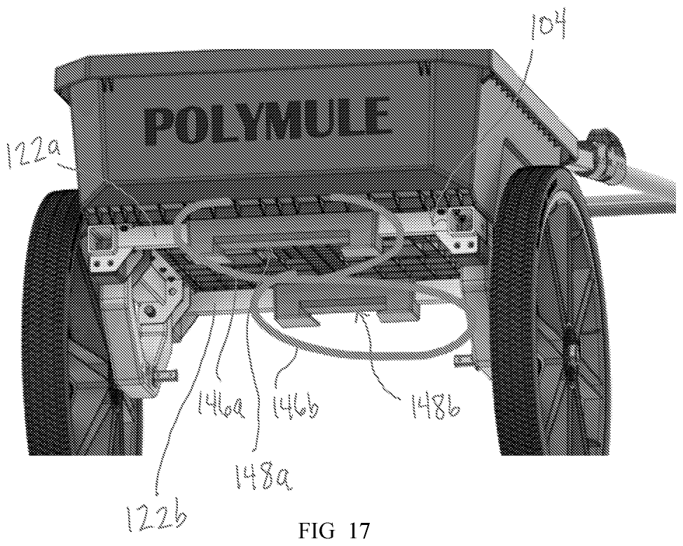

In at least one example, as shown in FIG. 17, the handcart 100 can include first and second hitch attachment accessories 146a and 146b, respectively, secured to the first and second elongate members 122a and 122b of the lower frame 104, respectively. In at least one example, the first hitch attachment accessory 146a can define a first platform receiving feature 148a and the second hitch attachment accessory 146b can define a second platform receiving feature 148b. The first platform receiving feature can be longer than the second receiving feature 148b to correspond to the wider width W1 of the first end 140 of the platform 138 and the second platform receiving feature 148b can be shorter to correspond to the narrower width W2 of the second end 142 of the platform 138.

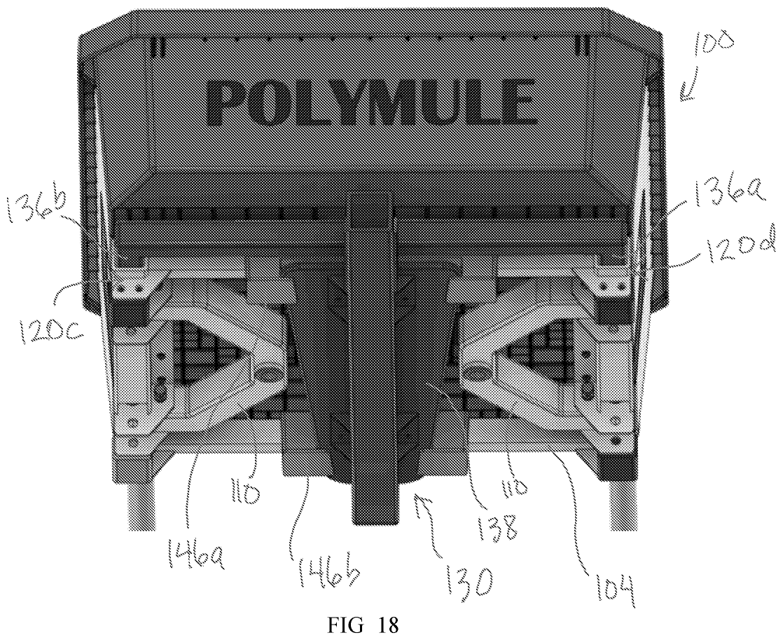

When mounting the handcart 100 to the hitch attachment, which can be secured to a vehicle hitch as noted above, the user can align the platform 138 with the first platform receiving feature 148a and slide the lower frame 104, and thus the handcart 100, along the platform 138 until the platform 138 is received by both the first and second receiving features of the first and second hitch attachment accessories 146a-b, respectively, as shown in FIG. 18. The hitch attachment is sized and configured such that the extensions 136a and 136b are received into the receivers 120c and 120d of the lower frame 104 as shown. The extensions 136a and 136b and/or the receivers 120a-d can include locking features to secure the handcart 100 to the hitch attachment 130.

When the handcart 100 is secured to the hitch attachment 130 as shown in FIG. 18, the platform 138 can at least partially support the weight of the handcart 100 while the lower frame 104 engages the extensions 136a-b at the receivers 120a-d to prevent the handcart 100 from sliding off the platform 138. As shown in FIG. 18, the struts 110 can be in a stowed position, and the wheels removed, when the handcart 100 is secured to the hitch attachment 130.

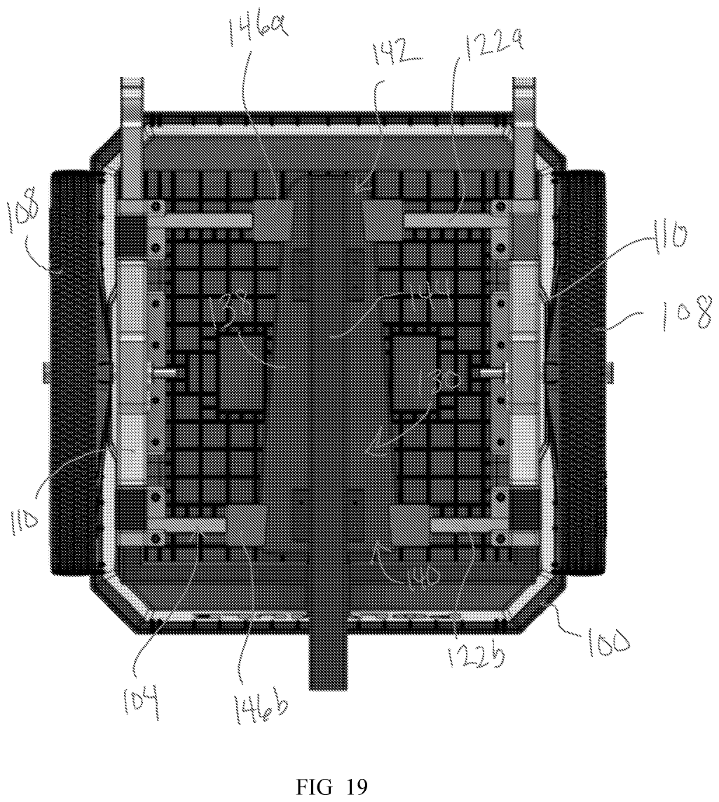

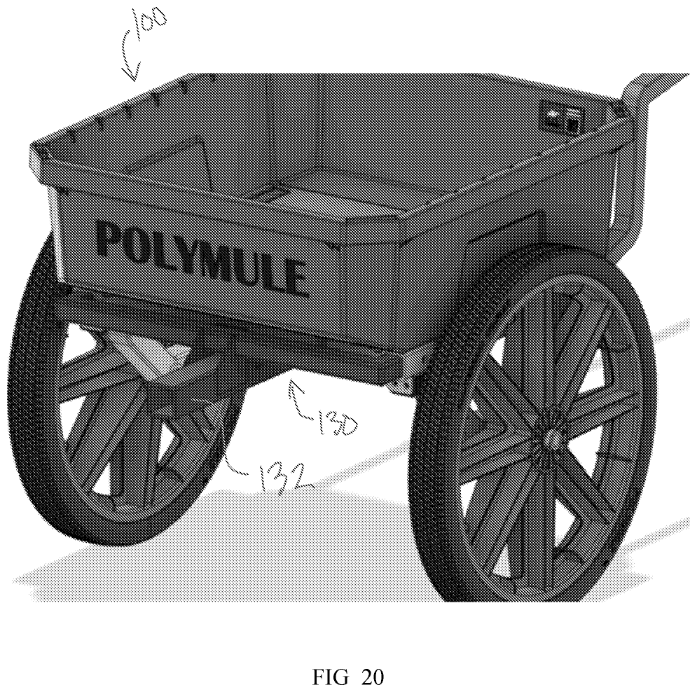

FIG. 19 shows the hitch attachment 130 secured to the handcart 100 from a bottom view. The handcart 100 can be secured with the wheels 108 still attached and the struts 110 still down, as shown in FIG. 19. FIG. 20 shows a rear, top, perspective view of a handcart 100 secured to a hitch attachment 130. The hitch insert 132 can extend away from the handcart 100 and be secured to a hitch receiver mounted to a vehicle, ATV, or other machine for transporting the handcart 100. Because of the tapered nature of the platform 138 and the size of the platform receiving features 148a-b, the handcart 100 can be easily aligned and slid onto the hitch attachment for quick, simple securement to a vehicle, even when the container 102 is loaded with gear or other objects. Once secured, the user can optionally fold the handle assembly 106 and struts 110 into stowed positions, including removing the wheels 108, for streamlined transport of the handcart 100.

Any of the features, components, and/or parts, including the arrangements and configurations thereof shown in FIGS. 16-20 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 16-20.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A cart, comprising:
a container;
a frame coupled to the container; and
an adjustable handle extending from the frame;
wherein:
the adjustable handle is configured to be selectively positioned downward relative to the container in a kickstand position; and
the adjustable handle is configured to be selectively folded in a stowed position.

2. A cart, comprising:
a container;
a first stowable strut coupled to the container;
a second stowable strut coupled to the container;
a first wheel rotatably coupled to the first stowable strut; and
a second wheel rotatably coupled to the second stowable strut;
wherein each of the first stowable strut and the second stowable strut is configured to be selectively lowered to increase a ground clearance below the container.

3. The cart of claim 2, wherein the first stowable strut and the second stowable strut define the ground clearance including a rectangular clearance area having a height equal to a radius of the first wheel plus a length of the strut.

4. A hitch attachment system for a cart, comprising:
a container; and
a hitch attachment coupled to the container, the hitch attachment including a tapered surface configured to mate with an attachment accessory.
